(19) United States
(12) Patent Application Publication
(10) Pub. No.: US 2011/0279767 A1
(43) Pub. Date: Nov. 17, 2011

(54) Liquid crystal display panel and its manufacturing method

(75) Inventor: Shinji Yamagishi, Osaka (JP)

(73) Assignee: Sharp Kabushiki Kaisha, Osaka (JP)

(21) Appl. No.: 13/137,065

(22) Filed: Jul. 19, 2011

Related U.S. Application Data
(62) Division of application No. 12/521,245, filed on Jun. 25, 2009.

(30) Foreign Application Priority Data
Apr. 13, 2007 (JP) 2007-105840

(51) Int. Cl. G02F 1/1339

(52) U.S. Cl. 349/190

(57) ABSTRACT

A liquid crystal display panel includes: a first substrate 10a made of glass; a second substrate 20a which is made of glass, is located so as to face the first substrate 10a, and has a smaller thickness than that of the first substrate 10a; a liquid crystal layer 25 provided between the first substrate 10a and the second substrate 20a; and a frame-shaped sealant 15a for bonding the first substrate 10a and the second substrate 20a to each other, and enclosing the liquid crystal layer 25 therebetween. The sealant 15a includes a first seal portion 15aa provided along a side where one of the first substrate 10a and the second substrate 20a protrudes with respect to the other, and a second seal portion 15ab which is provided along a side where respective end faces of the first substrate 10a and the second substrate 20a are aligned with each other, and which is provided so that an end face of the second seal portion 15ab is aligned with the substrate end faces, and so that the second seal portion 15ab has a smaller width than that of the first seal portion 15aa.

### TECHNICAL FIELD

The present invention generally relates to a liquid crystal display (LCD) panel and a manufacturing method thereof. More particularly, the present invention relates to a technique of cutting a glass substrate of an LCD panel.

### BACKGROUND ART

In recent years, there has been a growing demand for reduction in thickness and weight of a panel main body for improved portability, and for increase in display region with respect to outside dimensions of a panel, in LCD panels for use in mobile equipment applications such as cellular phones, portable digital assistants, and portable games.

As for reduction in thickness and weight, glass substrates for fabricating a TFT (Thin Film Transistor) substrate and a CF (Color Filter) substrate of an LCD panel have been reduced in thickness recently. More specifically, the panel thickness was conventionally 1.0 mm or more by combinations of a 0.7 mm-thick TFT substrate and a 0.7 mm-thick CF substrate, a 0.5 mm-thick TFT substrate and a 0.5 mm-thick CF substrate, and the like. In recent years, however, the panel thickness of less than 1.0 mm is becoming common by using combinations of a 0.4 mm-thick TFT substrate and a 0.4 mm-thick CF substrate, a 0.25 mm-thick TFT substrate and a 0.25 mm-thick CF substrate, and the like

As for increase in display region, it is possible to form a thin sealant for bonding a CF substrate and a TFT substrate in order to reduce the distance from an end face of each glass substrate of an LCD panel to a display region.

In the case of forming the sealant by a dispense method using a syringe, it is necessary to reduce the nozzle diameter of the syringe to form a thin sealant. Thus, the nozzle can get clogged while drawing the sealant, which causes not only a non-uniform width of the sealant, but also disconnections of the sealant, that is, discontinuous formation of the sealant.

Moreover, when the sealant is formed by a seal printing method using a screen printing plate, clogging of the screen printing plate can result in a non-uniform width of the sealant and disconnections of the sealant, as in the case of the dispense method.

Incidentally, the following two methods, for example, have been widely used as a method for cutting a pair of glass substrates bonded together through a sealant: a method described in Patent Document 1 and the like in which a low-temperature liquid material is injected from injecting means to an object at a high pressure, and the object is cut by thermal stress caused by local cooling; and a scribe method in which a linear scribe line is formed on the surfaces of glass substrates with a disc-shaped cutting blade, and then the glass substrates are cut into both sides along the scribe line.

If the glass substrates have a sealant in a region to which the low-temperature liquid material is to be injected, or in a cutting region such as a region where the scribe line is to be formed, the sealant tends to induce unintended breakage and cracks of the glass substrates, thereby causing defective cutting. Thus, it is necessary to form a sealant away from the cutting region of the glass substrates.

Moreover, it is necessary to form a sealant away from the cutting region of the glass substrates in view of the position accuracy of the syringe and the expansion and contraction of the screen printing plate when forming the sealant, the bonding accuracy when bonding a pair of glass substrates through the sealant, and the like.

Thus, it is difficult to form a thin sealant in view of the uniformity of the sealant width and the disconnections of the sealant as described above. Moreover, it is necessary to form a sealant away from the cutting region of the glass substrates in view of the defective cutting and the like. Increase in the display region has been limited with conventional manufacturing techniques.
Patent Document 1: Japanese Published Patent Application No. 2000-52299

### DISCLOSURE OF THE INVENTION

### Problems to be Solved by the Invention

Thus, the inventors considered a manufacturing technique for increasing a display region by reducing the width occupied by a sealant on glass substrates by cutting the glass substrates on the sealant.

More specifically, for example, after a bonded body was formed by bonding a 0.7 mm-thick TFT substrate and a 0.7 mm-thick CF substrate through a sealant, the glass substrates of the TFT substrate and the CF substrate were thinned by chemically polishing the respective surfaces of the TFT substrate and the CF substrate of the bonded body. Various LCD panels were fabricated by cutting the thinned bonded body substantially at a central position in the width direction of the sealant with a disc-shaped, hard metal cutting blade. As a result, the inventors found that this method reduces the width occupied by the sealant in the LCD panels, whereby LCD panels with a larger display region can be manufactured.

However, the intensive studies of the inventors showed that unintended cracks tend to be formed vertically in the cut end faces of the glass substrates in the manufactured LCD panels. Such unintended cracks can reduce the end face strength of the glass substrates to a level lower than the strength required for mobile equipments, and also, can result in the glass substrates with sawtooth (serrated) end faces, whereby predetermined outer dimensions cannot be obtained.

The present invention was developed in view of the above problems, and it is an object of the present invention to stabilize the outer dimensions of an LCD panel by suppressing reduction in end face strength, and to increase a display region.

### Means for Solving the Problems

In order to achieve the above object, according to the present invention, a sealant for bonding a first substrate and a second substrate to each other has a first seal portion, and a second seal portion having a smaller width than that of the first seal portion, and the second substrate is made thinner than the first substrate.

More specifically, an LCD panel according to the present invention includes: a first substrate made of glass; a second substrate which is made of glass, is located so as to face the first substrate, and has a smaller thickness than that of the first substrate; a liquid crystal layer provided between the first substrate and the second substrate; and a frame-shaped sealant for bonding the first substrate and the second substrate to each other, and enclosing the liquid crystal layer between the first substrate and the second substrate. The sealant includes a first seal portion provided along a side where one of the first substrate and the second substrate protrudes with respect to the other, and a second seal portion which is provided along a side where respective end faces of the first substrate and the second substrate are aligned with each other, and which is provided so that an end face of the second seal portion is aligned with the substrate end faces, and so that the second seal portion has a smaller width than that of the first seal portion.

According to the above structure, since the second substrate is formed thinner than the first substrate, the bonded body including the first substrate and the second substrate can be easily bent so that the second substrate faces inward, when cutting the bonded body on at least one side of the sealant. When the bonded body is cut on the sealant, the glass substrate to be cut first is cut in a desirable manner, while the glass substrate to be cut later tends to have only a crack formed in the surface thereof. Thus, after the relatively thin second substrate is cut in a desirable manner, a crack is formed in the surface of the relatively thick first substrate, and the bonded body having the cut second substrate is bent so that the second substrate faces inward. This causes the crack to run in the substrate thickness direction, and the first substrate is also cut in a desirable manner. Since no unintended crack is formed vertically in the cut end faces of the first substrate, reduction in end face strength is suppressed, and the outer dimensions are stabilized. Moreover, since the second seal portion having a smaller width than that of the first seal portion is formed along the first substrate and the second substrate which have been cut on the sealant, a display region can be increased by an amount corresponding to the difference in width between the first seal portion and the second seal portion. Thus, reduction in end face strength in the LCD panel can be suppressed, whereby the outer dimensions thereof are stabilized. Moreover, the display region can be increased.

A thickness ratio of the second substrate to the first substrate may be 0.9 or less.

According to the above structure, the second substrate becomes thinner than the first substrate, whereby the functions and effects of the present invention are specifically obtained.

A method for manufacturing an LCD panel according to the present invention includes: a bonded body formation step of forming a bonded body including a first substrate made of glass, a second substrate which is made of glass, is located so as to face the first substrate, and has a smaller thickness than that of the first substrate, and a frame-shaped sealant for bonding the first substrate and the second substrate to each other, and enclosing a liquid crystal layer between the first substrate and the second substrate; and a cutting step of cutting the bonded body formed in the bonded body formation step in an intermediate portion in a width direction of the sealant along at least one side of the sealant.

According to the above method, since the second substrate is formed thinner than the first substrate, the bonded body including the first substrate and the second substrate can be easily bent so that the second substrate faces inward, when cutting the bonded body on at least one side of the sealant in the cutting step. When the bonded body is cut on the sealant, the glass substrate to be cut first is cut in a desirable manner, while the glass substrate to be cut later tends to have only a crack formed in the surface thereof. Thus, after the relatively thin second substrate is cut in a desirable manner in the cutting step, a crack is formed in the surface of the relatively thick first substrate, and the bonded body having the cut second substrate is bent so that the second substrate faces inward. This causes the crack to run in the substrate thickness direction, and the first substrate is also cut in a desirable manner. Since no unintended crack is formed vertically in the cut end faces of the first substrate, reduction in end face strength is suppressed, and the outer dimensions are stabilized. Moreover, since the sealant is cut along the first substrate and the second substrate which have been cut on the sealant, and the width of the sealant is reduced, a display region is increased by an amount corresponding to the reduction in width of the sealant. Thus, reduction in end face strength in the LCD panel can be suppressed, whereby the outer dimensions thereof can be stabilized. Moreover, the display region can be increased.

The bonded body formation step may include a bonding step of bonding the first substrate and the second substrate to each other through the sealant.

According to the above method, the second substrate of the bonded body becomes thinner than the first substrate by bonding the pair of glass substrates having different thicknesses from each other. Thus, the functions and effects of the present invention are specifically obtained.

The bonded body formation step may include a bonding step of bonding a first original substrate for forming the first substrate and a second original substrate for forming the second substrate to each other through the sealant, and a thinning step of thinning at least one of the first original substrate and the second original substrate which have been bonded together in the bonding step.

According to the above method, the second substrate of the bonded body becomes thinner than the first substrate by thinning at least one of the first original substrate and the second original substrate after bonding the first original substrate and the second original substrate to each other. Thus, the functions and effects of the present invention are specifically obtained.

The thinning step may be performed by chemical polishing or mechanical polishing.

According to the above method, the second substrate of the bonded body becomes thinner than the first substrate by thinning at least one of the first original substrate and the second original substrate of the bonded body by chemical polishing or mechanical polishing. Thus, the functions and effects of the present invention are specifically obtained.

The bonded body may be cut with a disc-shaped cutting blade in the cutting step.

According to the above method, the bonded body is cut by rolling the cutting blade along the substrate surface while pressing an outer peripheral portion of the cutting blade against the surface of the first substrate and the second substrate on the sealant. Thus, the functions and effects of the present invention are specifically obtained.

In the bonded body formation step, multiple ones of the sealant may be provided between the first substrate and the second substrate, and a peripheral seal may be provided so as to surround the multiple ones of the sealant.

For example, terminals for display lines such as gate lines and source lines are positioned outside each sealant, and may be corroded by chemical polishing. According to the above method, however, since the peripheral seal provided so as to surround the multiple ones of the sealant prevents the terminals from being exposed to the outside during the chemical polishing, corrosion of the terminals by the chemical polishing is suppressed.

The bonded body having the liquid crystal layer enclosed between the first substrate and the second substrate may be formed in the bonded body formation step.

According to the above method, since the liquid crystal layer is enclosed between the first substrate and the second substrate in the bonded body formed in the bonded body formation step, a so-called one drop fill (ODF) method is specifically configured.

### Effects of the Invention

According to the present invention, a sealant for bonding a first substrate and a second substrate has a first seal portion and a second seal portion having a smaller width than the first seal portion, and the second substrate is thinner than the first substrate. Thus, reduction in end face strength in an LCD panel can be suppressed, whereby the outer dimensions thereof are stabilized. Moreover, a display region can be increased.

### BRIEF DESCRIPTION OF THE DRAWINGS

FIG. 1 is a plan view of an LCD panel 30a according to an embodiment of the present invention.

FIG. 2 is a cross-sectional view of the LCD panel 30a taken along line II-II in FIG. 1.

FIG. 3 is a plan view of a bonded body 30 for manufacturing the LCD panel 30a, when viewed from the TFT substrate side.

FIG. 4 is a plan view of the bonded body 30 for manufacturing the LCD panel 30a, when viewed from the CF substrate side.

FIG. 5 show cross-sectional views taken along line V-V in FIGS. 3 and 4, illustrating a part of a manufacturing process of the LCD panel 30a.

FIG. 6 is a plan view illustrating a method for measuring the outer dimensions of LCD panels of a practical example and a comparative example.

FIG. 7 is a top view schematically showing a cut end face of an LCD panel 30a of the practical example.

FIG. 8 is a perspective view illustrating a method for measuring the end face strength of the LCD panels of the practical example and the comparative example.

FIG. 9 is a top view schematically showing a cut end face of an LCD panel 130a of the comparative example.

FIG. 10 is a plan view of the LCD panel 130a of the comparative example.

FIG. 11 is a cross-sectional view of the LCD panel 130a taken along line XI-XI in FIG. 10.

### DESCRIPTION OF THE REFERENCE SYMBOLS

C crack
H hard metal wheel (cutting blade)
10 TFT mother substrate (first substrate)
10a TFT substrate (first substrate)
10s TFT original substrate (first original substrate)
15a sealant
15aa first seal portion
15ab second seal portion
16 peripheral seal
20 CF mother substrate (second substrate)
20a CF substrate (second substrate)
20s CF original substrate (second original substrate)
liquid crystal layer
30, 30s bonded body
30a LCD panel

### BEST MODE FOR CARRYING OUT THE INVENTION

Hereinafter, an embodiment of the present invention will be described in detail based on the accompanying drawings. Note that the present invention is not limited to the following embodiment.

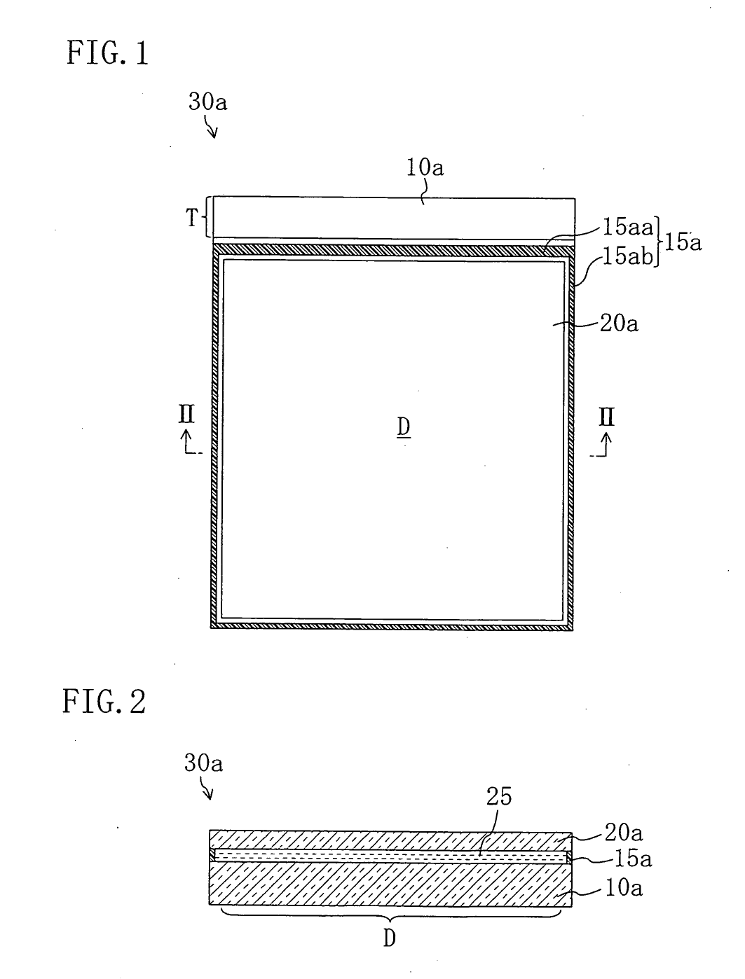

FIG. 1 is a plan view of an LCD panel 30a of the present embodiment, and FIG. 2 is a cross-sectional view of the LCD panel 30a taken along line II-II in FIG. 1.

As shown in FIGS. 1 and 2, the LCD panel 30a includes a TFT substrate (first substrate) 10a and a CF substrate (second substrate) 20a which are positioned so as to face each other, a liquid crystal layer 25 provided between the TFT substrate 10a and the CF substrate 20a, and a sealant 15a formed in a rectangular frame shape for bonding the TFT substrate 10a and the CF substrate 20a to each other, and enclosing the liquid crystal layer 25 therebetween.

The TFT substrate 10a includes a plurality of gate lines (not shown) extending parallel to each other on a glass substrate, a plurality of source lines (not shown) extending parallel to each other and perpendicularly to the gate lines, a plurality of TFTs (not shown) provided at each intersection of the gate lines and the source lines, and a plurality of pixel electrodes (not shown) respectively connected to the TFTs.

The CF substrate 20a includes a color filter layer (not shown) provided on the glass substrate, and a common electrode (not shown) provided on the color filter layer.

The color filter layer has a plurality of colored layers each colored red, green, or blue corresponding to the respective pixel electrodes on the TFT substrate 10a, and a black matrix provided between the colored layers. Note that the pixel electrodes on the TFT substrate 10a and the colored layers on the CF substrate 20a are arranged in a matrix pattern to form a display region D.

The liquid crystal layer 25 is made of a liquid crystal material including nematic liquid crystal having electro-optic characteristics.

The thickness of the CF substrate 20a is at most 0.9 times the thickness of the TFT substrate 10a, and is at least 0.01 mm.

As shown in FIG. 1, the sealant 15a includes a first seal portion 15aa provided along the upper side of the CF substrate 20a, and a second seal portion 15ab provided along the left, lower, and right sides of the CF substrate 20a. The line width of the second seal portion 15ab (e.g., 0.6 mm) is about one-half of the line width of the first seal portion 15aa (e.g., 1.2 mm). Note that, as shown in FIG. 1, an outer end of the first seal portion 15aa is located 0.2 mm to 0.3 mm inside an end face (upper side) of the CF substrate 20a, and an outer end of the second seal portion 15ab is aligned with end faces (left, lower, and right sides) of both the TFT substrate 10a and the CF substrate 20a.

As shown in FIG. 1, an upper side part of the TFT substrate 10a protrudes from the CF substrate 20a to form a terminal region T, and a plurality of input terminals respectively connected to display lines such as the gate lines and the source lines are provided in the terminal region T.

The LCD panel 30a of the above structure has a pixel for every pixel electrode, and by applying a voltage of a predetermined magnitude to the liquid crystal layer 25 in each pixel, the orientation state of the liquid crystal layer 25 is changed to adjust, for example, the transmittance of light entering from a backlight, thereby displaying an image.

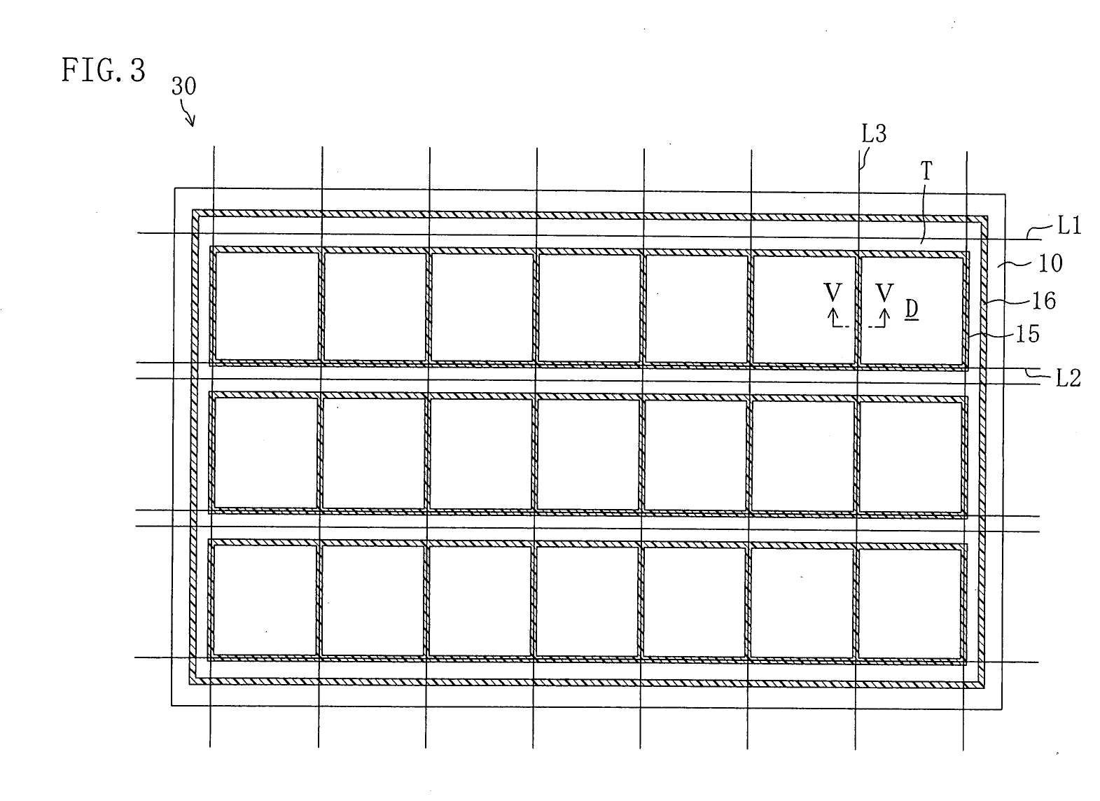

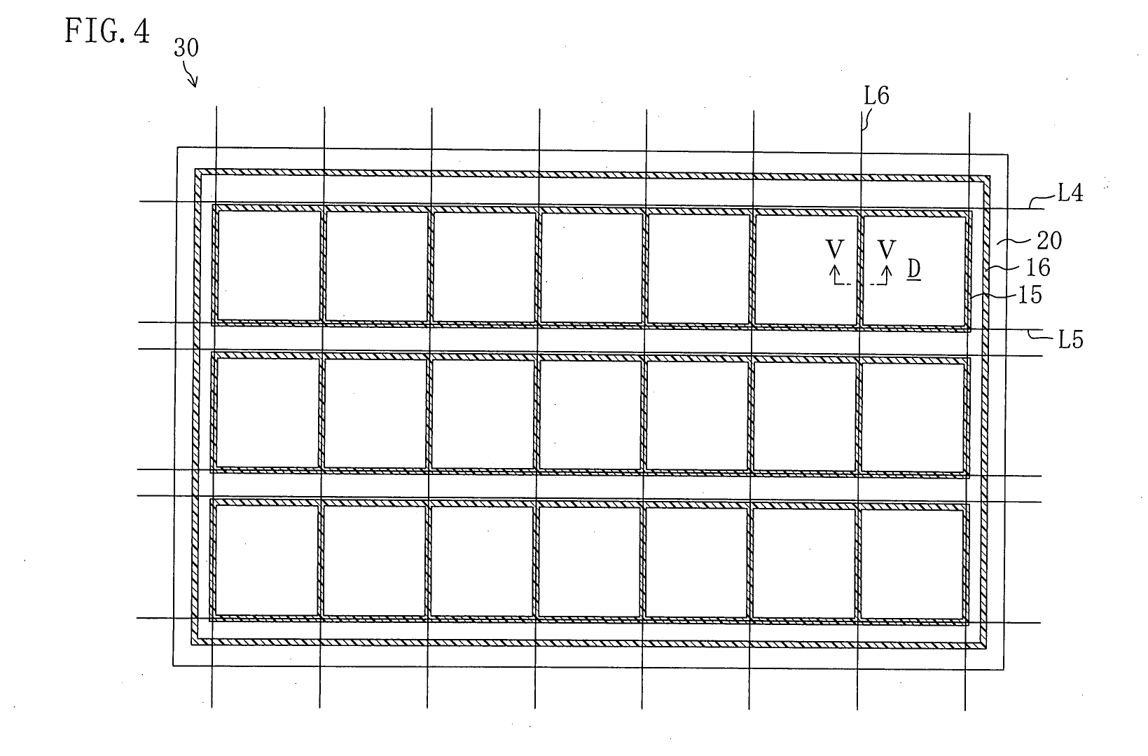

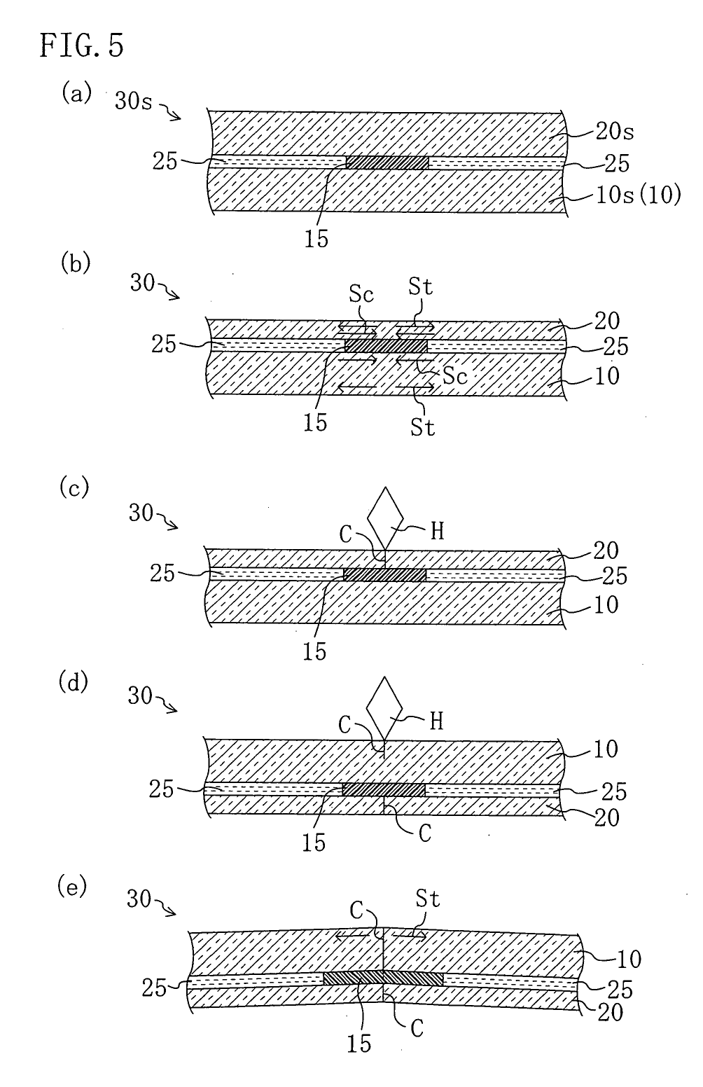

A method for manufacturing the LCD panel 30a of the above structure will be described below with reference to FIGS. 3 through 5. FIG. 3 is a plan view of a bonded body 30 for manufacturing the LCD panel 30a when viewed from the TFT substrate side, and FIG. 4 is a plan view of the bonded body 30 when viewed from the CF substrate side. FIG. 5 show cross-sectional views taken along line V-V in FIGS. 3 and 4, illustrating a part of a manufacturing process of the LCD panel 30a. Note that the manufacturing method of the present embodiment includes a substrate fabrication step, a seal formation step, a bonded body formation step, and a cutting step.

[Substrate Fabrication Step]

TFTs, pixel electrodes, and the like are patterned on, for example, a 0.7 mm×320 nm×400 mm glass substrate to form a plurality of active element layers each forming a display region D. Then, an alignment film is formed over the substrate surface. A TFT original substrate 10s having a plurality of display regions D defined in a matrix pattern is fabricated in this manner (see a TFT mother substrate 10 in FIG. 3).

Moreover, a color filter, a common electrode, and the like are patterned on a 0.7 mm×320 mm×400 mm glass substrate to form a plurality of CF element layers each forming a display region D. Then, an alignment film is formed over the substrate surface. A CF original substrate 20s having a plurality of display regions D defined in a matrix pattern is fabricated in this manner (see a CF mother substrate 20 in FIG. 4).

Note that, as shown in FIGS. 3 and 4, the 0.7 mm×320 mm×400 mm glass substrates produce twenty-one 50 mm×100 mm LCD panels at a time.

### [Seal Formation Step]

For example, an acrylic/epoxy resin is drawn by a seal dispenser along the periphery of each display region D of the CF original substrate 20s to form a plurality of sealants 15 and a peripheral seal 16 surrounding the plurality of sealants 15 (see FIG. 4). Note that, since a plurality of display regions D are successively defined along the substrate longitudinal direction in the present embodiment, each pair of adjacent display regions D share the sealant 15 located therebetween.

[Bonded Body Formation Step]

First, a liquid crystal material is dropped to, for example, the inside of each display region D of the TFT original substrate 10s.

Then, the TFT original substrate 10s having the liquid crystal material dropped thereon, and the CF original substrate 20s having the sealants 15 and the peripheral seal 16 formed thereon are bonded in a vacuum atmosphere so that the respective display regions D are superimposed on each other. The TFT original substrate 10s and the CF original substrate 20s are then returned to an atmospheric atmosphere to press the respective surfaces thereof, thereby forming a bonded body 30s having a liquid crystal layer 25 enclosed therein, as shown in FIG. 5(a) (bonding step). The line width of the sealants 15 is increased to 1.2 mm along each side as a result of pressing the substrates.

Moreover, a chemical-resistant protective film is applied to the TFT original substrate 10s side of the bonded body 30s, and then a chemical polishing process (chemical etching process) is performed to reduce the thickness of the CF original substrate 20s to 0.2 mm, thereby fabricating a bonded body 30 (thinning step). In the chemical polishing process, the thickness of the CF original substrate 20s may be reduced by using, for example, a method of immersing the bonded body 30s in an aqueous solution containing 10 wt % of hydrofluoric acid and 5 wt % of hydrochloric acid, while generating air bubbles by supplying air into the aqueous solution in order to remove a by-product from the glass substrates.

[Cutting Step]

It is considered that, as shown in FIG. 5(b), the bonded body 30 before cutting the CF mother substrate 20 is subjected to a compressive stress Sc in the respective surfaces of the TFT mother substrate 10 and the CF mother substrate 20 which are in contact with the sealant 15, and is subjected to a tensile stress St in the respective surfaces of the TFT mother substrate 10 and the CF mother substrate 20 which are not in contact with the sealant 15.

Thus, a hard metal wheel H is rolled along cutting lines L4, L5, and L6 in FIG. 4 while placing a blade tip of the hard metal wheel H as follows. Along the cutting lines L5 and L6 in FIG. 4, the blade tip of the hard metal wheel H is placed in a middle portion in the width direction of the sealant 15 on the surface of the CF mother substrate 20 of the bonded body 30, as shown in FIG. 5(c). Along the cutting line L4 in FIG. 4, the blade tip of the hard metal wheel H is placed at a position located 0.2 mm to 0.3 mm outside the sealant 15. The hard metal wheel H is rolled in this manner to form a crack C in the surface of the CF mother substrate 20, and to cause the crack C to run in the substrate thickness direction, thereby cutting the CF mother substrate 20 of the bonded body 30 (first cutting step). In this first cutting step, a tensile stress St is applied to the surface of the CF mother substrate 20 on the sealant 15. Thus, by forming a crack C in the surface of the CF mother substrate 20, the crack C runs in the substrate thickness direction, whereby the CF mother substrate 20 is cut on the sealant 15.

Note that the hard metal wheel H is a disc-shaped cutting blade made of a hard metal such as tungsten carbide, and is configured so that the side surfaces of the disc protrude toward the middle in the thickness direction in a tapered manner. The hard metal wheel H may have a protrusion at the tapered blade tip.

Then, the bonded body 30 with the cut CF mother substrate 20 is reversed, and the hard metal wheel H is rolled along cutting lines L1, L2, and L3 in FIG. 3, while placing the blade tip of the hard metal wheel H as follows. Along the cutting lines L2 and L3 in FIG. 3, the blade tip of the hard metal wheel H is placed in the middle portion in the width direction of the sealant 15, that is, at a position of the cut end face of the CF mother substrate 20, on the surface of the TFT mother substrate 10 of the bonded body 30, as shown in FIG. 5(d). Along the cutting line L1 in FIG. 3, the blade tip of the hard metal wheel H is placed at a position outside a region forming the terminal region T. The hard metal wheel H is rolled in this manner to form a crack C in the surface of the TFT mother substrate 10 (second preliminary cutting step). Since the CF mother substrate 20 has been cut on the sealant 15, a reduced tensile stress St is applied to the surface of the TFT mother substrate 10 on the sealant 15 in the second preliminary cutting step. Thus, only a crack C is formed in the surface of the TFT mother substrate 10 on the sealant 15.

Moreover, as shown in FIG. 5(e), the bonded body 30 having the crack C formed in the TFT mother substrate 10 is bent so that the CF mother substrate 20 faces inward through the crack C, thereby cutting the TFT mother substrate 10 along the crack C (second main cutting step). In this second main cutting step, a tensile stress St is applied to the surface of the TFT mother substrate 10 on the sealant 15 when the bonded body 30 having the crack C formed in the surface of the TFT mother substrate 10 is bent so that the CF mother substrate 20 faces inward. Therefore, the crack C formed in the surface of the TFT mother substrate 10 runs in the substrate thickness direction, whereby the TFT mother substrate 10 is cut. At this time, the sealant 15 is cut simultaneously with the TFT mother substrate 10, forming a first seal portion 15aa and a second seal portion 15ab. The bonded body 30 is divided into display regions D in this manner.

Note that, in addition to the method of bending the substrate as described above, the crack C formed in the surface of the TFT mother substrate 10 can be accurately caused to run by, for example, a method of applying a mechanical pressure and impact by a glass breaking machine or the like.

The LCD panel 30a can be manufactured in this manner.

Next, specific experiments performed will be described below.

As a practical example of the present embodiment, an LCD panel 30a was manufactured by the same method as that in the embodiment described above (hereinafter referred to as the “cutting method A”). As a comparative example, an LCD panel 130a having a display region D with the same size as that of a display region D of the LCD panel 30a of the practical example was manufactured by a method of cutting substrates at a position located 0.2 mm to 0.3 mm outside a sealant (hereinafter referred to as the “cutting method B”) (see FIGS. 10 and 11). FIG. 10 is a plan view of the LCD panel 130a of the comparative example, and FIG. 11 is a cross-sectional view of the LCD panel 130a taken along line XI-XI in FIG. 10.

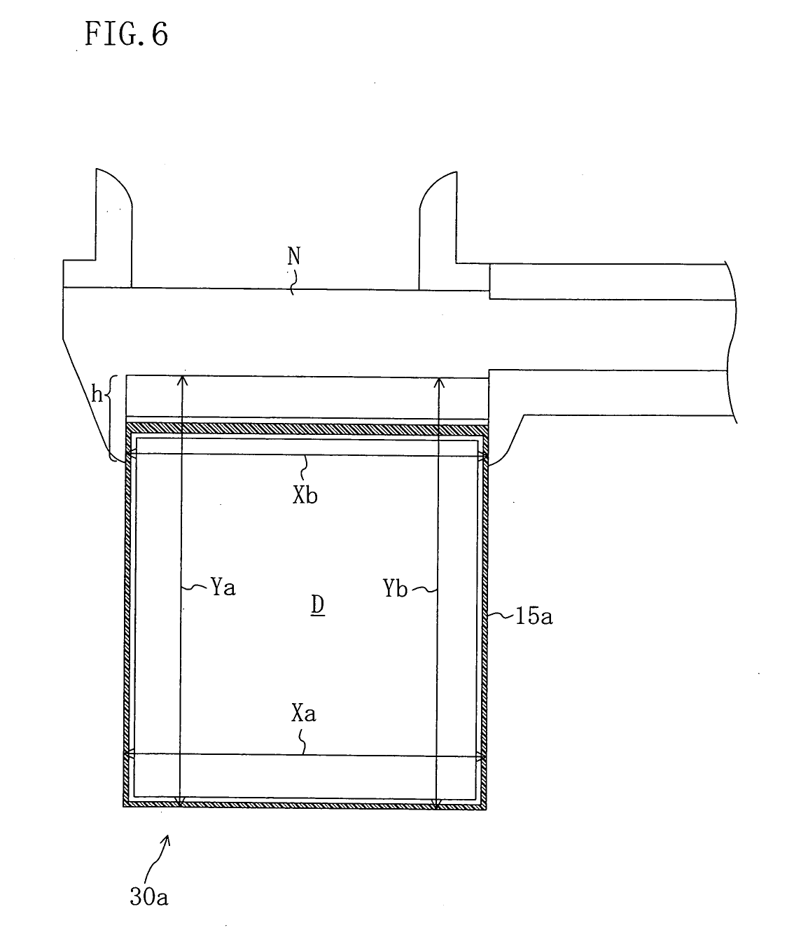

First, the outer dimensions of the LCD panels 30a and 130a respectively manufactured by the cutting methods A and B were measured with vernier calipers N (h=20 mm), as shown in FIG. 6. Note that, as shown in FIG. 6, the outer dimensions of the LCD panel 30a (130a) were measured at two positions (Xa and Xb) on the shorter side and two positions (Ya and Yb) on the longer side.

Table 1 shows the measurement result.

TABLE 1

| OUTER | CUTTING | CUTTING |
|---|---|---|
| DIMENSIONS (mm) | METHOD A | METHOD B |
| SHORTER SIDE | 48.2 (±0.051) | 50.0 (±0.050) |
| LONGER SIDE | 99.1 (±0.050) | 100.0 (±0.051) |

As shown in Table 1, although the display regions D of the practical example (the cutting method A) and the comparative example (the cutting method B) have the same size, the outer dimensions of the practical example were 1.8 mm smaller on the shorter side, and 0.9 mm smaller on the longer side than the comparative example. This is because the seal width is reduced to one-half of 1.2 mm, that is, 0.6 mm, along three sides of the sealant 15 by cutting the substrates in the middle portion of the sealant 15, and the space of about 0.3 mm from the substrate end face to the sealant 115 in the LCD panel 130a of the comparative example is eliminated on the three sides of the sealant 15.

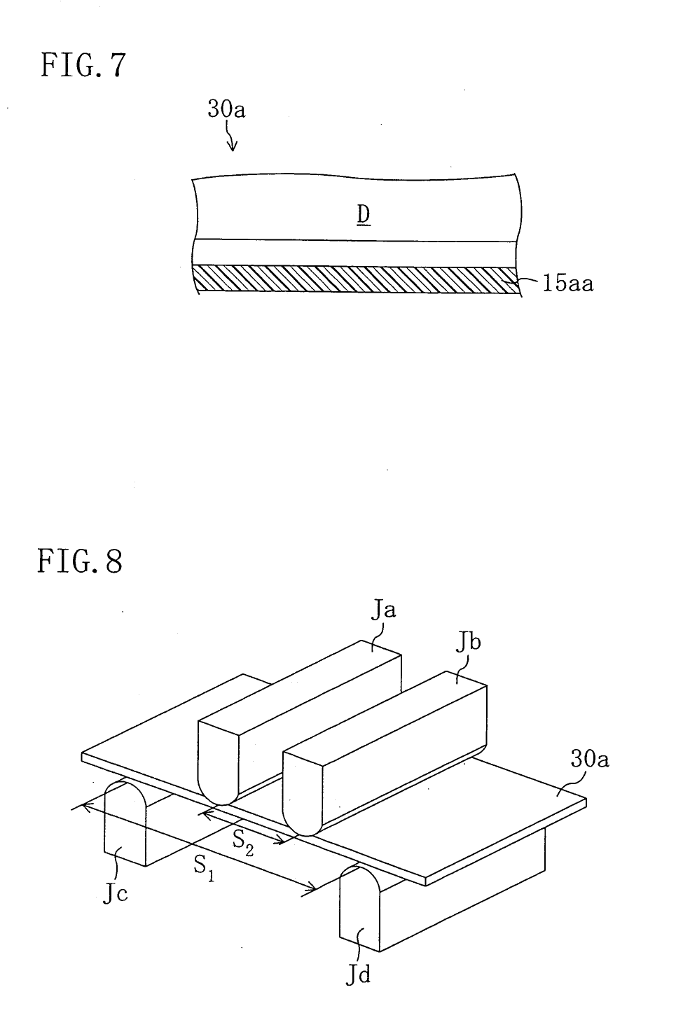

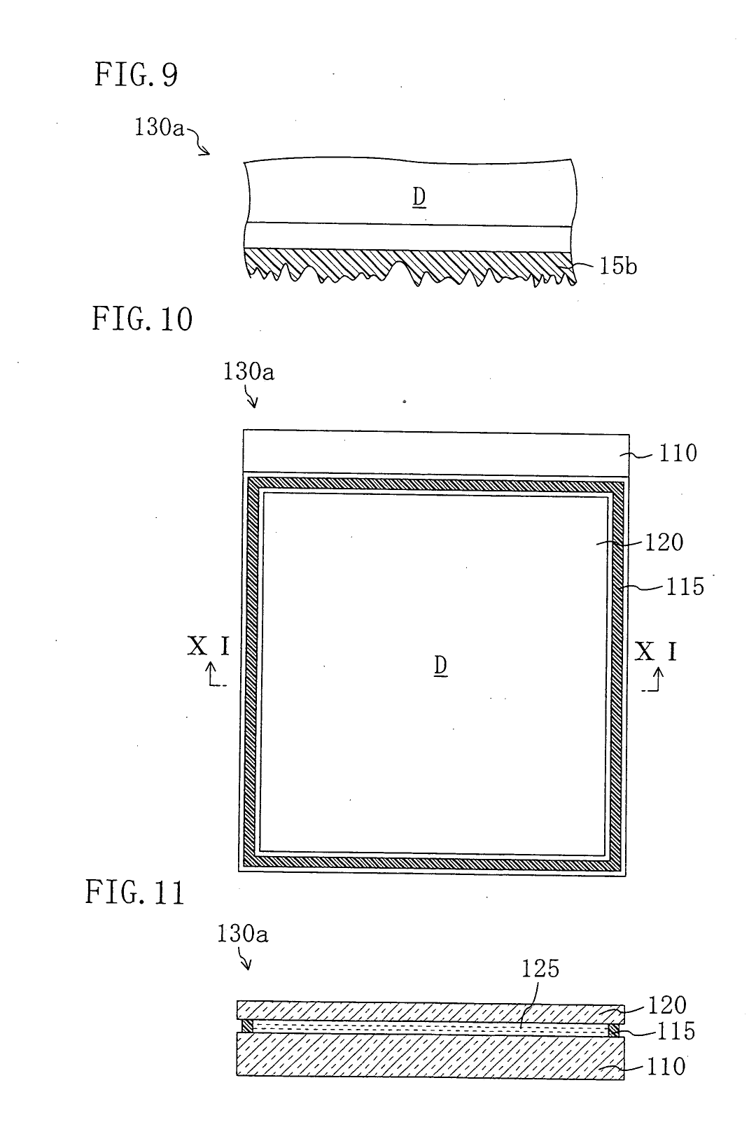

Moreover, observation of each cut end face of the LCD panels 30a and 130a shows that the LCD panel 30a of the practical example had linear cut end faces as shown in FIG. 7, while the LCD panel 130a of the comparative example had sawtooth (serrated) cut end faces as shown in FIG. 9.

Then, the end face strength of the LCD panels 30a and 130a respectively manufactured by the cutting methods A and B was measured by performing a strength test commonly called a “four-point bend test” with a strength test machine as shown in FIG. 8. Since the LCD panels 30a and 130a have different outer dimensions as described above, each LCD panel was manufactured with the outer dimensions shown in Table 2 below to compare the strength. Note that the TFT substrate and the CF substrate had a thickness of 0.7 mm and 0.2 mm, respectively.

TABLE 2

| | | MEAN END | MEAN | IMPROVE- |
|---|---|---|---|---|
| | | FACE | END FACE | MENT |
| SHORTER- | LONGER- | STRENGTH | STRENGTH | RATIO |
| SIDE | SIDE | OF | OF | OF END |
| OUTER | OUTER | CUTTING | CUTTING | FACE |
| DIMEN- | DIMENSION | METHOD A | METHOD B | STRENGTH |
| SION (mm) | (mm) | (N) | (N) | (%) |
| 48.2 | 99.1 (±0.047) | 249.2 | 214.8 | 16.1 |
| (±0.052) | | | | |

The conditions of the strength test machine are as follows.

1) Distance S₂ between upper press jigs (Ja and Jb): 20 mm

2) Distance S₁ between lower substrate support jigs (Jc and Jd): 40 mm

3) Pressing speed of the upper press jigs: 5 mm/min.

The maximum pressing value before the LCD panel was broken was measured, and the mean value of the measured values for 10 panels was calculated as the end face strength of the LCD panel.

As shown in Table 2, the result shows that the end face strength of the LCD panel of the practical example, which was produced by the cutting method A of cutting the middle portion of the sealant, was improved by 16.1% over the LCD panel of the comparative example, which was produced by the cutting method B of cutting outside the sealant.

Next, the relation between the thickness combination of the TFT substrate and the CF substrate, and the end face strength of the LCD panel was examined.

More specifically, each LCD panel was manufactured with the outer dimensions shown in Table 3 below, and the strength was compared by the strength test described above. Note that a cutting method C shown in Table 3 is a method of cutting the substrates at a position located 0.2 mm to 0.3 mm outside the sealant as in the case of the cutting method B.

TABLE 3

| | GLASS | | | | | |
|---|---|---|---|---|---|---|
| | SUBSTRATE | SHORTER- | LONGER- | MEAN END FACE | MEAN END FACE | IMPROVEMENT |
| | THICKNESS | SIDE OUTER | SIDE OUTER | STRENGTH OF | STRENGTH OF | RATIO OF END |
| | COMBINATION | DIMENSION | DIMENSION | CUTTING METHOD A | CUTTING METHOD C | FACE STRENGTH |
| | (mm) | (mm) | (mm) | (N) | (N) | (%) |
| No. 1 | 0.7/0.6 | 48.2 | 99.1 | 506.1 | 467.3 | 8.3 |
| | (0.86) | (±0.051) | (±0.046) | | | |
| No. 2 | 0.4/0.2 | 48.2 | 99.1 | 128.1 | 97.4 | 31.5 |
| | (0.50) | (±0.039) | (±0.034) | | | |
| No. 3 | 0.2/0.1 | 48.2 | 99.1 | 32.8 | 22.7 | 44.7 |
| | (0.50) | (±0.027) | (±0.028) | | | |
| No. 4 | 0.2/0.15 | 48.2 | 99.1 | 46.3 | 34.1 | 35.8 |
| | (0.75) | (±0.031) | (±0.034) | | | |
| No. 5 | 0.2/0.18 | 48.2 | 99.1 | 49.4 | 38.7 | 27.6 |
| | (0.90) | (±0.038) | (±0.039) | | | |
| No. 6 | 0.7/0.65 | 48.2 | 99.1 | 377.1 | 487.9 | −22.7 |
| | (0.93) | (±0.109) | (±0.095) | | | |
| No. 7 | 0.3/0.3 | 48.2 | 99.1 | 31.2 | 98.9 | −68.5 |
| | (1.00) | (±0.185) | (±0.134) | | | |
| No. 8 | 0.2/0.19 | 48.2 | 99.1 | 39.2 | 42.8 | −8.4 |
| | (0.95) | (±0.077) | (±0.082) | | | |

As shown in Table 3, the result shows that the end face strength improved when the thickness ratio of the CF substrate to the TFT substrate was 0.90 or less as in the case of Condition Nos. 1 to 5, while the end face strength reduced when the thickness ratio of the CF substrate to the TFT substrate exceeded 0.90 as in the case of Condition Nos. 6 to 8. This is considered to occur for the following reason. In the case where the thickness ratio of the CF substrate to be cut first to the TFT substrate to be cut later is 0.90 or less, the substrates of the bonded body become asymmetric in thickness, and it becomes easier to bend the bonded body so that the thinner CF substrate faces inward in the second main cutting step of the present embodiment. Thus, a bending stress (tensile stress) is applied around the crack formed in the surface of the TFT substrate, and the crack runs in a desirable manner in the substrate thickness direction. On the other hand, in the case where the thickness of the CF substrate to be cut first is equal to that of the TFT substrate to be cut later, the substrates of the bonded body become symmetric in thickness, and it becomes more difficult to bend the bonded body. Thus, a bending stress and a compressive stress repel each other at the surface of the TFT substrate, preventing the crack from running in a desirable manner in the substrate thickness direction.

The above specific experiments performed show that the glass substrates can be cut on the sealant in a desirable manner by configuring an LCD panel so that the thickness ratio of the CF substrate to the TFT substrate becomes 0.90 or less. Moreover, this confirmed that the width occupied by the sealant in the LCD panel is reduced, whereby the display region can be increased, and that the outer dimensions are stabilized, and the end face strength can be improved.

As described above, according to the LCD panel 30a of the present embodiment and the manufacturing method thereof, the CF original substrate 20s is thinned after the TFT original substrate 10s and the CF original substrate 20s are bonded together. Since the CF mother substrate 20 becomes thinner than the TFT mother substrate 10 in the bonded body 30, the bonded body 30 can be more easily bent so that the CF mother substrate 20 faces inward, when cutting the bonded body 30 on the sealant 15 in the cutting step. When the bonded body 30 is cut on the sealant 15, the glass substrate to be cut first is cut in a desirable manner, while the glass substrate to be cut later tends to have only a crack formed in the surface thereof. Thus, after the relatively thin CF mother substrate 20 is cut in a desirable manner in the cutting step, a crack C is formed in the surface of the relatively thick TFT mother substrate 10, and the bonded body 30 having the cut CF mother substrate 20 is bent so that the CF mother substrate 20 faces inward. This causes the crack C formed in the surface of the TFT mother substrate 10 to run in the substrate thickness direction, and the TFT mother substrate 10 is also cut in a desirable manner. Since no unintended crack is formed vertically in the cut end faces of the TFT mother substrate 10, reduction in end face strength can be suppressed, and the outer dimensions can be stabilized. Moreover, since the sealant 15 is cut into a smaller width along the TFT substrate 10a and the CF substrate 20a which have been cut on the sealant 15, the display region D can be increased by an amount corresponding to the reduction in width of the sealant 15. Thus, reduction in end face strength is suppressed in the LCD panel 30a, and the outer dimensions thereof can be stabilized, and also, the display region D can be increased. This improves the quality and the manufacturing yield of the LCD panel.

Moreover, the terminal region T having a plurality of terminals for display lines such as gate lines and source lines arranged therein is located outside each sealant 15, and the terminals may be corroded by chemical polishing. According to the present embodiment, however, since the peripheral seal 16 provided so as to surround the plurality of sealants 15 prevents the terminal regions T from being exposed to the outside during the chemical polishing, corrosion of the terminals by the chemical polishing can be suppressed.

Moreover, in the present embodiment, a method of thinning the glass substrate by chemical polishing was described as an example. However, the glass substrate may be thinned by mechanical polishing (polishing and grinding with abrasive grains) in the present invention. Moreover, the present invention is not limited to thinning the glass substrate of the bonded body, but a pair of glass substrates having different thicknesses from each other may be bonded together.

Moreover, in the present embodiment, a manufacturing method using an ODF method was described as an example. However, the present invention is applicable also to a manufacturing method using a dip injection method of forming a sealant having a liquid crystal injection port.

Moreover, in the present embodiment, a method of dividing the glass substrate on three sides of the sealant 15 was described as an example. However, the width occupied by the sealant can be reduced by dividing the glass substrate on at least one side of the sealant.

Moreover, in the present embodiment, a method of dividing the TFT mother substrate 10 and the CF mother substrate 20 in the middle portion in the width direction of the sealant 15 was described as an example. However, the width occupied by the sealant can be reduced by cutting the TFT mother substrate 10 and the CF mother substrate 20 in an intermediate portion in the width direction of the sealant 15. The term “middle” in the middle portion herein means the central position in the width direction of the sealant, and the term “intermediate” in the intermediate portion indicates any position between both ends in the width direction of the sealant.

Moreover, the present embodiment was described with respect to the case where the CF mother substrate 20 (second substrate) was formed thinner than the TFT mother substrate 10 (first substrate). However, the present invention is applicable also to the case where the CF mother substrate is formed thicker than the TFT mother substrate, that is, the case where the first substrate is the CF mother substrate, and the second substrate is the TFT mother substrate. Note that, in this case, by replacing the “CF mother substrate 20” and the “TFT mother substrate 10” with a “TFT mother substrate” and a “CF mother substrate,” respectively, in the above embodiment, an LCD panel having a CF mother substrate formed thicker than a TFT mother substrate can be manufactured, and improvement in end face strength and stabilization of outer dimensions can be achieved as shown in the result of Table 3.

### INDUSTRIAL APPLICABILITY

As described above, the present invention enables a display region to be increased, and thus, is useful for LCD panels for mobile equipment applications requiring a narrower frame.

1-2. (canceled)

3. A method for manufacturing a liquid crystal display panel, comprising:
a bonded body formation step comprising forming a bonded body including a first substrate made of glass, a second substrate which is made of glass, is located so as to face the first substrate, and has a smaller thickness than that of the first substrate, and a frame-shaped sealant for bonding the first substrate and the second substrate to each other, and enclosing a liquid crystal layer between the first substrate and the second substrate; and
a cutting step comprising cutting the bonded body formed in the bonded body formation step in an intermediate portion in a width direction of the sealant along at least one side of the sealant, wherein
in the cutting step, a side of the first substrate of the bonded body is cut after a side of the second substrate of the bonded body is cut.

4. The method of claim 3, wherein the bonded body formation step includes a bonding step of bonding the first substrate and the second substrate to each other through the sealant.

5. The method of claim 3, wherein the bonded body formation step includes
a bonding step of bonding a first original substrate for forming the first substrate and a second original substrate for forming the second substrate to each other through the sealant, and
a thinning step of thinning at least one of the first original substrate and the second original substrate which have been bonded together in the bonding step.

6. The method of claim 5, wherein the thinning step is performed by chemical polishing or mechanical polishing.

7. The method of claim 3, wherein the bonded body is cut with a disc-shaped cutting blade in the cutting step.

8. The method of claim 3, wherein in the bonded body formation step, multiple ones of the sealant are provided between the first substrate and the second substrate, and a peripheral seal is provided so as to surround the multiple ones of the sealant.

9. The method of claim 3, wherein the bonded body having the liquid crystal layer enclosed between the first substrate and the second substrate is formed in the bonded body formation step.
